(19) United States
(12) Patent Application Publication
(10) Pub. No.: US 2011/0205222 A1
(43) Pub. Date: Aug. 25, 2011

(54) METHOD FOR DRIVING LIQUID CRYSTAL DISPLAY DEVICE

(75) Inventors: HUAN-TING ZHOU, Sanchong City (TW); Shian-jun Chiou, Taipei City (TW); Ling Li, Hualien City (TW); Ying-hui Chen, Taoyuan City (TW); Wen-chih Tai, Zhongli City (TW); Chia-lin Liu, Daya Shiang (TW); Chi-neng Mo, Zhongli City (TW)

(73) Assignee: CHUNGHWA PICTURE TUBES, LTD., Bade City (TW)

(21) Appl. No.: 12/774,708

(22) Filed: May 5, 2010

(30) Foreign Application Priority Data
Feb. 24, 2010 (TW) 099105377

(51) Int. Cl. G09G 3/36; G09G 5/00

(52) U.S. Cl. 345/213; 345/204; 345/99

(57) ABSTRACT

A method for driving a liquid crystal display device is disclosed. The liquid crystal display device includes a plurality of scan lines, a plurality of data lines, and a plurality of pixel units. Each one of the pixel units is corresponding to one of the scan lines and one of the data lines. The method includes: turning on at least two of the scan lines at the same time, said at least two scan lines being separated from each other by at least one turned off scan line, and said at least two scan lines respectively coupled to distinct one or multiple of the data lines; and transmitting respective image data to the data lines which are coupled to said at least two scan lines. The present invention can solve problems of bad performance and errors in a display image.

### TECHNICAL FIELD OF THE INVENTION

The present invention relates to a liquid crystal display device, and more particularly to a method for driving a liquid crystal display device.

### BACKGROUND OF THE INVENTION

A liquid crystal display device display area mainly includes a plurality of scan lines, a plurality of data lines, and a plurality of pixel units which are disposed as a matrix form. Each one of the pixel units is coupled to and controlled by one of the scan lines and one of the data lines for displaying images. Each one of the pixel units has a thin film transistor served as a switch element. When one of the scan lines is turned on, the pixel units which are coupled to said scan line will be coupled to the corresponding data lines for receiving image data. Furthermore, the pixel units which are coupled to said scan line will be charged to proper voltages by the corresponding data lines. Then, said scan line is turned off. Said scan line will not receive new image data until it is turned on again. The next one of said scan lines is turned on and the above-mentioned steps are repeated for receiving the image data.

A driving principle of a color sequential method is to sequentially switch a red backlight source, a blue backlight source, and a green backlight source in time domain for displaying required colors. Since it is necessary to switch the backlight sources quickly in the color sequential method, the corresponding response time of liquid crystals has to be short. Please refer to FIG. 1, which illustrates a timing chart of the color sequential method in the prior art. The time period of the color sequential method may be divided into three parts. The first part is denoted as T_{TFT}, which includes time for turning on and charging the thin film transistor of each one of the pixel units. The second part is denoted as T_{LC}, which includes time for rotating the liquid crystals to expected grey levels by the voltages applied to the thin film transistors. The third part is denoted as T_{BL}, which includes time for flashing the red backlight source after the liquid crystals have been rotated to the expected grey levels. Only ⅓ frame of one color image is finished at this time. Then, the green backlight source and the blue backlight source are driven sequentially for finishing one complete frame of the color image. Since it is necessary to sequentially switch the red backlight source, the blue backlight source, and the green backlight source in the time domain for displaying the required colors of one color image, the liquid crystals have to be characterized in short response time and the thin film transistors have to be characterized also in short charge time in the color sequential method.

The requirement for an update frequency of the liquid crystal display device is high at present. When a scan frequency is 240 Hertz (Hz) and resolution is 1600×900 (i.e. 1600 data lines and 900 scan lines), the charge time of each scan line of the liquid crystal display device which is driven by the color sequential method is estimated as follows:

$$\frac{1}{240} \div 900 = 4.6 µs$$

According to characteristics of the liquid crystal display at present, the charge time of each pixel unit requires at least 7 μs. If an interval time between one display image and the next one display image is considered, the charge time of each pixel unit has to be at least great than 9 μs. The problem of charge time deficiency may be solved by turning on a plurality of scan lines at the same time. For example, when the charge time is doubled or tripled by turning on two or three scan lines at the same time, the charge time is increased as 9.2 μs or 13.8 μs.

To maintain the voltage which is achieved after charging until the image is updated again, each pixel unit utilizes a storage capacitor (Cs) for storing the voltage. In general, there are Cs-on-gate type and Cs-on-common type of storage capacitors. The Cs-on-gate type of storage capacitor is formed between a display electrode and a gate line. The Cs-on-common type of storage capacitor is formed between a display electrode and a common line. Because the Cs-on-gate type does not require the extra common line while the Cs-on-common type requires, an aperture ratio of the Cs-on-gate type is greater than that of the Cs-on-common type. As a result, the Cs-on-gate type of storage capacitor is utilized mostly now.

Please refer to FIG. 2, which illustrates an equivalent circuit of a conventional liquid crystal display device using the Cs-on-gate type of storage capacitor. A pixel unit 10 includes a liquid crystal capacitor C_{LC}, a storage capacitor C_{S}, and a thin film transistor 100. The pixel unit 10 is coupled to a corresponding scan line 102 and a corresponding data line 104. Because the storage capacitor C_{S} is formed as the Cs-on-gate type, the storage capacitor C_{S} is coupled to a previous gate line 106. That is, when the scan line 102 is switched from an “off” state to an “on” state, a voltage difference of the storage capacitor C_{S} is affected by the scan line 102 and the scan 106 (i.e. the previous scan line). The voltage difference of the storage capacitor C_{S} is called a feedthrough voltage.

As mentioned above, the plurality of scan lines have to be turned on at the same time for solving the problem of charge time deficiency. However, when any three sequential scan lines, Gn, Gn+1, and Gn+2, are turned on at the same time in the Cs-on-gate type of storage capacitor, either a white strip, a black strip, and a black strip in a group, or a black strip, a white strip, and a white strip in a group will be repeated and displayed in an all-white display image. The reason is that the feedthrough voltage of each scan line is affected by the previous scan line. The previous scan line of the scan line Gn (i.e. Gn−1) is turned off, and the previous scan lines of the scan line Gn+1, Gn+2 (i.e. Gn, Gn+1) are turned on. As a result, the feedthrough voltage of the scan line Gn+1 and the feedthrough voltage of the Gn+2 are the same, but the feedthrough voltage of the scan line Gn is different from the feedthrough voltage of the scan line Gn+1 and the feedthrough voltage of the Gn+2. That is, the liquid crystal voltage of each pixel unit of the scan line Gn is different from the liquid crystal voltage of each pixel unit of the scan line Gn+1 and the liquid crystal voltage of each pixel unit of the scan line Gn+2. Therefore, the all-white display image cannot be displayed normally, instead, the white-black-black strips (or the black-white-white strips) are repeated and displayed in the all-white display image.

Therefore, there is a need for a solution to the above-mentioned problem that mura or uneven brightness occurs in the liquid crystal display device which is driven by the color sequential method.

### SUMMARY OF THE INVENTION

A primary objective of the present invention is to provide a method for driving a liquid crystal display device, which is capable of solving the problem of mura or uneven brightness in a display image when a plurality of sequential scan lines are turned on at the same time.

The method for driving the liquid crystal display device according to the present invention, wherein the liquid crystal display device comprises a plurality of scan lines, a plurality of data lines, and a plurality of pixel units, and each one of the pixel units is corresponding to one of the scan lines and one of the data lines, the method comprises steps of: turning on at least two of the scan lines at the same time, said at least two scan lines being separated from each other by at least one turned off scan line, and said at least two scan lines respectively coupled to distinct one or multiple of the data lines; and transmitting respective image data to the data lines which are coupled to said at least two scan lines.

Since said at least two scan lines are turned on at the same time and said least two scan lines are separated from each other by said at least one turned off scan lines, the method for driving the liquid crystal display device according to the present invention is capable of solving the problem of mura or uneven brightness in a display image and the problem of deficiency charge time. Furthermore, said at least two scan lines are respectively coupled to distinct one or multiple of the data lines so as to prevent several scan lines which are coupled to the same data line from being turned on at the same time. As a result, the problem of display errors may be avoided.

### BRIEF DESCRIPTION OF THE DRAWINGS

FIG. 1 illustrates a timing chart of the color sequential method in the prior art;

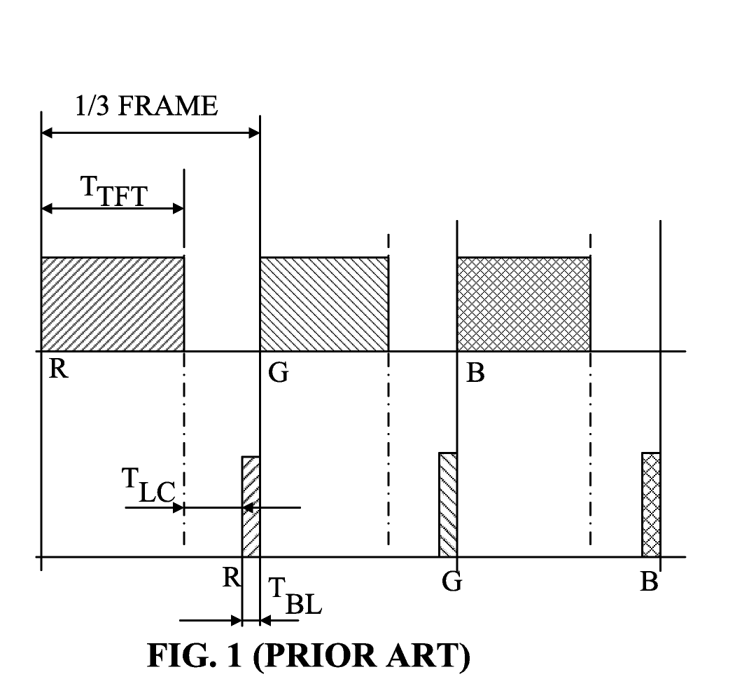

FIG. 2 illustrates an equivalent circuit of a conventional liquid crystal display device using the Cs-on-gate type of storage capacitor;

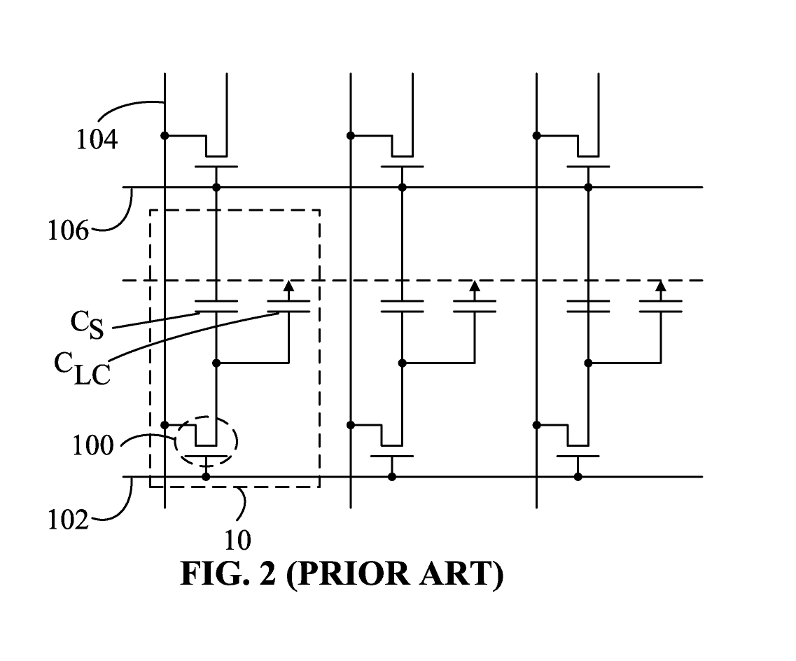

FIG. 3 illustrates an architectural diagram of a method for driving a liquid crystal display device according to one embodiment of the present invention; and

FIG. 4 illustrates a timing diagram for controlling the scan lines according to the first embodiment of the present invention.

### DETAILED DESCRIPTION OF THE INVENTION

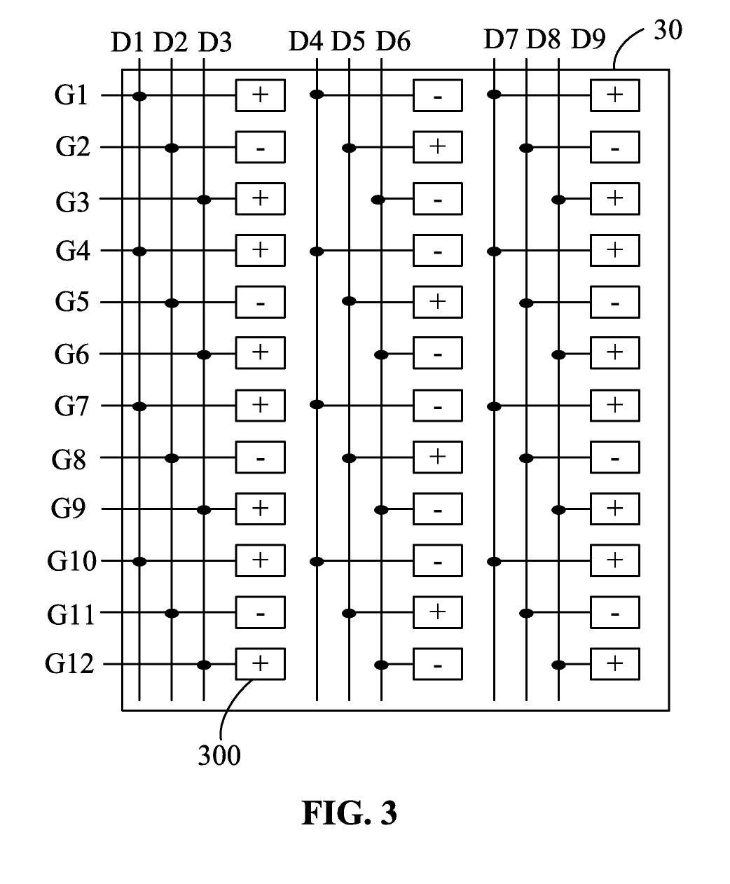

Please refer to FIG. 3, which illustrates an architectural diagram of a method for driving a liquid crystal display device 30 according to one embodiment of the present invention. The liquid crystal display device 30 comprises a plurality of scan lines G1-G12, a plurality of data lines D1-D9, and a plurality of pixel units 300. Each pixel unit 300 is corresponding to one of the scan lines G1-G12 and one of the data lines D1-D12. In the method for driving the liquid crystal display device 30, several of the scan lines G1-G12 are turned on at the same time for increasing the charge time. Said turned on scan lines are separated from each other by at least one turned off scan line. The purpose of said at least one turned off scan lines is to prevent the different feedthrough voltages. That is, when the sequential scan lines are turned on at the same time, the problem that the different feedthrough voltages are affected by the previous scan line may be avoided. Said at least two scan lines are respectively coupled to distinct one or multiple of the data lines. The purpose of this will be described later. Three embodiments which meet the above-mentioned conditions will be described. The steps of the method according to a first embodiment of the present invention are described as follows.

The scan lines G1, G5, G9 are turned on at the same time. The scan lines G2-G4 between the scan line G1 and the scan line G5 are turned off. The scan lines G6-G8 between the scan line G5 and the scan line G9 are turned off. The data lines which are respectively coupled to the scan line G1, the data lines which are respectively coupled to the scan line G5, and the data lines which are respectively coupled to the scan line G9 are different. In the present embodiment, the data lines D1, D4, D7 are respectively coupled to the scan line G1, the data lines D2, D5, D8 are respectively coupled to the scan line G5, and the data lines D3, D6, D9 are respectively coupled to the scan line G9.

Respective image data are transmitted to the data lines D1, D4, D7 which are coupled to the scan line G1, the data lines D2, D5, D8 which are coupled to the scan line G5, and the data lines D3, D6, D9 which are coupled to the scan line G9. The pixel units 300 corresponding to the data lines D1-D9 receive and store the respective image data.

Then, the scan lines G2, G6, G10 are turned on at the same time. The scan lines G3-G5 between the scan line G2 and the scan line G6 are turned off. The scan lines G7-G9 between the scan line G6 and the scan line G10 are turned off. The data lines which are respectively coupled to the scan line G2, the data lines which are respectively coupled to the scan line G6, and the data lines which are respectively coupled to the scan line G10 are different. In the present embodiment, the data lines D2, D5, D8 are respectively coupled to the scan line G2, the data lines D3, D6, D9 are respectively coupled to the scan line G6, and the data line D1, D4, D7 are respectively coupled to the scan line G10.

Respective image data are transmitted to the data lines D2, D5, D8 which are coupled to the scan line G2, the data lines D3, D6, D9 which are coupled to the scan line G6, and the data lines D1, D4, D7 which are coupled to the scan line G10. The pixel units 300 corresponding to the data lines D1-D9 receive and store the respective image data.

Further, the scan lines G3, G7, G11 are turned on at the same time. The scan lines G4-G6 between the scan line G3 and the scan line G7 are turned off. The scan lines G8-G10 between the scan line G7 and the scan line G11 are turned off. The data lines which are respectively coupled to the scan line G3, the data lines which are respectively coupled to the scan line G7, and the data lines which are respectively couple to the scan line G11 are different. In the present embodiment, the data lines D3, D6, D9 are respectively coupled to the scan line G3, the data lines D1, D4, D7 are respectively coupled to the scan line G7, and the data lines D2, D5, D8 are respectively coupled to the scan line G11.

Respective image data are transmitted to the data lines D3, D6, D9 which are coupled to the scan line G3, the data lines D1, D4, D7 which are coupled to the scan line G7, and the data lines D2, D5, D8 which are coupled to the scan line G11. The pixel units 300 corresponding to the data lines D1-D9 receive and store the respective image data.

Finally, the scan lines G4, G8, G12 are turned on at the same time. The scan lines G5-G7 between the scan line G4 and the scan line G8 are turned off. The scan lines G9-G11 between the scan line G8 and the scan line G12 are turned off. The data lines which are respectively coupled to the scan line G4, the data lines which are respectively coupled to the scan line G8, and the data lines which are respectively coupled to the scan line G12 are different. In the present embodiment, the data lines D1, D4, D7 are respectively coupled to the scan line G4, the data lines D2, D5, D8 are respectively coupled to the scan line G8, and the data lines D3, D6, D9 are respectively coupled to the scan line G12.

Respective image data are transmitted to the data lines D1, D4, D7 which are coupled to the scan line G4, the data lines D2, D5, D8 which are coupled to the scan line G8, and the data lines D3, D6, D9 which are coupled to the scan line G12. The pixel units 300 corresponding to the data lines D1-D9 receive and store the respective image data.

In the present embodiment, when any three scan lines are turned on at the same time, for example, G1, G5, G9, the scan line G1 and the scan line G5 are separated from each other by three turned off scan lines, and the scan line G5 and the scan line G9 are separated from each other by three turned off scan lines. In another embodiment, the number of the turned off scan lines between the scan line G1 and the scan line G5 and the number of the turned off scan lines between the scan line G5 and the scan line G9 may be different.

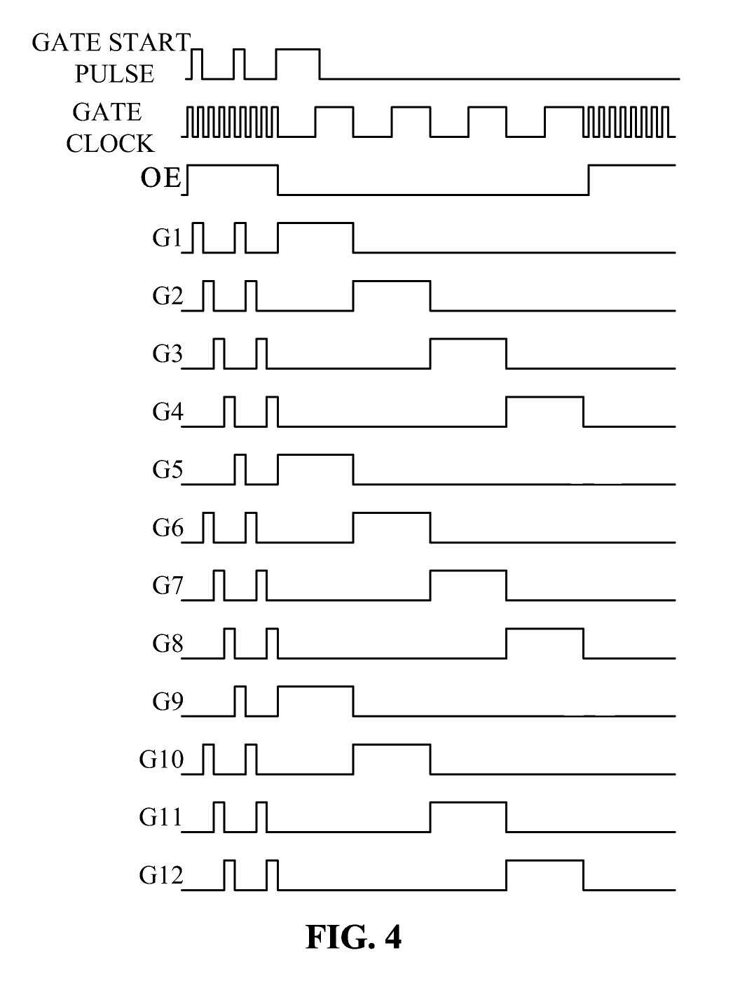

Please refer to FIG. 4, which illustrates a timing diagram for controlling the scan lines according to the first embodiment of the present invention. Firstly, an enable signal OE is turned on for delaying inputs of all signals without performing any scan actions. That is, when the enable signal OE is at a high level, the scan lines G1-G12 will not be turned on. The enable signal OE represents interval time between one display image and the next display image. When the enable signal OE is switched from a high level to a low level, a gate start pulse is triggered by a first negative edge (i.e. the moment from a high level to a low level) of a gate clock and scan actions start. Firstly, the scan lines G1, G5, G9 are turned on at the same time. Then, when the gate start pulse is triggered by a second negative edge of the gate clock, the scan lines G1, G5, G9 are turned off, and the scan lines G2, G6, G10 are turned on at the same time. When the gate start pulse is triggered by a third negative edge of the gate clock, the scan lines G2, G6, G10 are turned off, and the scan lines G3, G7, G11 are turned on at the same time. Finally, when the gate start pulse is triggered by a fourth negative edge of the gate clock, the scan lines G3, G7, G11 are turned off, and the scan lines G4, G8, G12 are turned on at the same time for completing the scan actions of one display image. The scan actions are repeated cyclically as mentioned above.

The steps of a second embodiment according to spirit of the present invention are described as follows.

The scan lines G1, G3 are turned on at the same time. The scan line G2 between the scan line G1 and the scan line G3 is turned off. The data lines which are respectively coupled to the scan line G1 are different from the data lines which are respectively coupled to the scan line G3. In the present embodiment, the data lines D1, D4, D7 are respectively coupled to the scan line G1, and the data lines D3, D6, D9 are respectively coupled to the scan line G3.

Respective image data are transmitted to the data lines D1, D4, D7 which are coupled to the scan line G1, and the data lines D3, D6, D9 which are coupled to the scan line G3. The pixel units 300 corresponding to the data lines D1, D4, D7, D3, D6, D9 receive and store the respective image data.

Then, the scan lines G2, G4 are turned on at the same time. The scan line G3 between the scan line G2 and the scan line G4 is turned off. The data lines which are respectively coupled to the scan line G2 are different from the data lines which are respectively coupled to the scan line G4. In the present embodiment, the data lines D2, D5, D8 are respectively coupled to the scan line G2, and the data lines D1, D4, D7 are respectively coupled to the scan line G4.

Respective image data are transmitted to the data lines D2, D5, D8 which are coupled to the scan line G2, and the data lines D1, D4, D7 which are coupled to the scan line G4. The pixel units 300 corresponding to the data lines D2, D5, D8, D1, D4, D7 receive and store the respective image data.

The turned on sequence of the scan lines G5-G8 is the same as the turned on sequence of the scan lines G1-G4. That is, the scan lines G5, G7 are turned on at the same time, and respective image data are transmitted to the data lines D2, D5, D8 which are coupled to the scan line G5, and the data lines D1, D4, D7 which are coupled to the scan line G7. The pixel units 300 corresponding to the data lines D2, D5, D8, D1, D4, D7 receive and store the respective image data. Then, the scan lines G6, G8 are turned on at the same time, and respective image data are transmitted to the data lines D3, D6, D9 which are coupled to the scan line G6, and the data lines D2, D5, D8 which are coupled to the scan line G8. The pixel units 300 corresponding to the data lines D3, D6, D9, D2, D5, D8 receive and store the respective image data.

Finally, the turned on sequence of the scan lines G9-G12 is the same the turned on sequence of the scan lines G1-G4 and the turned on sequence of the scan lines G5-G8. That is, the scan lines G9, G11 are turned on at the same time, and respective image data are transmitted to the data lines D3, D6, D9 which are coupled to the scan line G9, and the data lines D2, D5, D8 which are coupled to the scan line G11. The pixel units 300 corresponding to the data lines D3, D6, D9, D2, D5, D8 receive and store the respective image data. Then, the scan lines G10, G12 are turned on at the same time, and respective image data are transmitted to the data lines D1, D4, D7 which are coupled to the scan line G10, and the data lines D3, D6, D9 which are coupled to the scan line G12. The pixel units 300 corresponding to the data lines D1, D4, D7, D3, D6, D9 receive and store the respective image data.

The steps of a third embodiment according to spirit of the present invention are described as follows.

The scan lines G1, G3, G5 are turned on at the same time. The scan line G2 between the scan line G1 and the scan line G3 is turned off. The scan line G4 between the scan line G3 and the scan line G5 is turned off. The data lines which are respectively coupled to the scan line G1, the data lines which are respectively coupled to the scan line G3, and the data lines which are respectively coupled to the scan line G5 are different. In the present embodiment, the data lines D1, D4, D7 are respectively coupled to the scan line G1, the data lines D3, D6, D9 are respectively coupled to the scan line G3, and the data lines D2, D5, D8 are respectively coupled to the scan line G5.

Respective image data are transmitted to the data lines D1, D4, D7 which are coupled to the scan line G1, the data lines D3, D6, D9 which are coupled to the scan line G3, and the data lines D2, D5, D8 which are coupled to the scan line G5. The pixel units 300 corresponding to the data lines D1-D9 receive and store the respective image data.

Further, the scan lines G2, G4, G6 are turned on at the same time. The scan line G3 between the scan line G2 and the scan line G4 is turned off. The scan line G5 between the scan line G4 and the scan line G6 is turned off. The data lines which are respectively coupled to the scan line G2, the data lines which are respectively coupled to the scan line G4, and the data lines which are respectively coupled to the scan line G6 are different. In the present embodiment, the data lines D2, D5, D8 are respectively coupled to the scan line G2, the data lines D1, D4, D7 are respectively coupled to the scan line G4, and the data lines D3, D6, D9 are respectively coupled to the scan line G6.

Respective image data are transmitted to the data lines D2, D5, D8 which are coupled to the scan line G2, the data lines D1, D4, D7 which are coupled to the scan line G4, and the data lines D3, D6, D9 which are coupled to the scan line G6. The pixel units 300 corresponding to the data lines D1-D9 receive and store the respective image data.

The turned on sequence of the scan lines G7-G12 is the same as the turned on sequence of the scan lines G1-G6. That is, the scan lines G7, G9, G11 are turned on at the same time, and respective image data are transmitted to the data lines D1, D4, D7 which are coupled to the scan line G7, the data lines D3, D6, D9 which are coupled to the scan line G9, and the data lines D2, D5, D8 which are coupled to the scan line G11. The pixel units 300 corresponding to the data lines D1-D9 receive and store the respective image data. Then, the scan lines G8, G10, G12 are turned on at the same time, and respective image data are transmitted to the data lines D2, D5, D8 which are coupled to the scan line G8, the data lines D1, D4, D7 which are coupled to the scan line G10, and the data lines D3, D6, D9 which are coupled to the scan line G12. The pixel units 300 corresponding to the data lines D1-D9 receive and store the respective image data.

Timing diagrams for controlling the scan lines according to the second and third embodiments of the present invention are similar to that of the first embodiment of the present invention, and detailed descriptions are not repeated herein.

To sum up the above-mentioned embodiments according to the present invention, the method for driving the liquid crystal display device turns on at least two of the scan lines so that the charge time may be increased as at least twice and voltage saturation rate may be increased. In addition, said at least two scan lines are separated from each other by at least one turned off scan line, so as to prevent different feedthrough voltages which are resulted from signal interference between adjacent scan lines. Finally, said at least two scan lines are respectively coupled to distinct one or multiple of the data lines so as to ensure only one of the scan lines, which are coupled to the same data line, being turned on at the same time. For instance, if the scan lines G1, G4, G7 are turned on at the same time, the pixel units 300 corresponding to the scan lines G1, G4, G7 and the data line D1 will receive the same image data, that is, receive the same grey level display voltage. However, each pixel unit 300 may not require the same grey level display voltage. If the grey level display voltage received by each pixel unit 300 is different from the grey level display voltage required in practice, color shift phenomenon will occur in the liquid crystal display device.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method for driving a liquid crystal display device, the liquid crystal display device comprising a plurality of scan lines, a plurality of data lines, and a plurality of pixel units, each one of the pixel units corresponding to one of the scan lines and one of the data lines, the method comprising steps of:
turning on at least two of the scan lines at the same time, said at least two scan lines being separated from each other by at least one turned off scan line, and said at least two scan lines respectively coupled to distinct one or multiple of the data lines; and
transmitting respective image data to the data lines which are coupled to said at least two scan lines.

2. The method for driving the liquid crystal display device of claim 1, wherein the scan lines are disposed to be perpendicular to the data lines.

3. The method for driving the liquid crystal display device of claim 1, wherein the pixel units receive and store the respective image data in the step of transmitting the respective image data to the data lines which are coupled to said at least two scan lines.

4. The method for driving the liquid crystal display device of claim 1, wherein an enable signal is utilized for controlling the starting of turning on the scan lines.

5. The method for driving the liquid crystal display device of claim 4, wherein when the enable signal is switched from a first level to a second level, a gate start pulse is triggered by an edge of a gate clock so as to start the step of turning on the at least two of the scan lines at the same time.

6. The method for driving the liquid crystal display device of claim 5, wherein the first level is a high level, the second level is a low level, and the edge of the gate clock is a negative edge.

7. The method for driving the liquid crystal display device of claim 1, wherein a pulse signal is utilized to turn on said at least two of the scan lines at the same time.

8. The method for driving the liquid crystal display device of claim 1, wherein when at least three of the scan lines are turned on at the same time, the number of the turned off scan line or scan lines between every two adjacent ones of the turned on scan lines is the same.

9. The method for driving the liquid crystal display device of claim 1, wherein when at least three of the scan lines are turned on at the same time, the numbers of the turned off scan line or scan lines between every two adjacent ones of the turned on scan lines are different.
